(19) United States
(12) Patent Application Publication
(10) Pub. No.: US 2026/0163772 A1
(43) Pub. Date: Jun. 11, 2026

(54) Communication apparatus and method having frequency tracking mechanism

(71) Applicant: REALTEK SEMICONDUCTOR CORPORATION, Hsinchu (TW)

(72) Inventor: FENG-XIANG WANG, Suzhou (CN)

(21) Appl. No.: 19/367,114

(22) Filed: Oct. 23, 2025

(30) Foreign Application Priority Data
Oct. 28, 2024 (CN) 202411506787.9

(51) Int. Cl. H04L 27/00

(52) U.S. Cl. CPC H04L 27/0014; H04L 2027/0026

(57) ABSTRACT

A communication apparatus having a frequency tracking mechanism is provided. A phase compensation circuit performs phase compensation on a packet according to a frequency offset to generate a phase-compensated symbol section for a symbol processing circuit to descramble and equalize thereon to generate a phase difference and a difference from a previous symbol section such that a residual frequency offset estimation circuit calculates a ratio to generate an instant frequency offset estimation value. A frequency offset smoothing calculation circuit performs calculation according to a function having a positive correlation with the difference to generate a modification coefficient to be multiplied by the instant frequency offset estimation value and a smoothing coefficient to generate a smoothed frequency offset estimation value and adds a previous frequency offset estimation value by the smoothed frequency offset estimation value to generate a current frequency offset estimation value to update the frequency offset.

### BACKGROUND OF THE INVENTION

### Field of the Invention

The present invention relates to a communication apparatus and a communication method having a frequency tracking mechanism.

### Description of Related Art

Ultra-Wideband (UWB) technology based on IEEE 802.15.4a/f/z standard is a wireless communication technology that performs data transmission utilizing narrow pulses in the scale of nanosecond. According to the standard of the UWB technology, the modulation of a data part is involved with Burst Position Modulation (BPM) to avoid the interference between different apparatuses that continuously perform data transmission simultaneously for a long time.

When a communication apparatus performs communication, a crystal oscillator frequency deviation or Doppler effect may cause a frequency offset. When the frequency offset estimation is performed based on the preamble section, a residual frequency offset may exist such that the frequency offset tracking is still required in the data section to avoid the occurrence of a larger degree of phase offset. In order to lower the error in the frequency offset tracking, the tracking results corresponding to a plurality of symbols are needed to be smoothed. The conventional frequency offset tracking technology only sets fixed smooth parameters according to the signal to noise ratio (SNR). However, when the burst position modulation technology is applied, the time interval between neighboring data varies such that the frequency offset tracking accuracy varies as well. The technology that utilizes the fixed parameters cannot accomplish the best frequency offset tracking result.

### SUMMARY OF THE INVENTION

In consideration of the problem of the prior art, an object of the present invention is to supply a communication apparatus and a communication method having a frequency tracking mechanism.

The present invention discloses a communication apparatus having a frequency tracking mechanism that includes a phase compensation circuit, a symbol processing circuit, a residual frequency offset estimation circuit and a frequency offset smoothing calculation circuit. The phase compensation circuit is configured to receive a current symbol section of a data part of a packet and perform a phase compensation on the current symbol section according to a frequency offset to generate a phase-compensated symbol section. The symbol processing circuit is configured to descramble and equalize the phase-compensated symbol section according to descrambling information to generate an equalization result, so as to perform calculation based on the equalization result to generate a phase difference and a data time difference between the phase-compensated symbol section and a previous symbol section. The residual frequency offset estimation circuit is configured to perform calculation of a ratio between the phase difference and the data time difference to generate an instant frequency offset estimation value. The frequency offset smoothing calculation circuit is configured to perform calculation on the data time difference according to a function having a positive correlation with the data time difference to generate a modification coefficient, so as to multiply the instant frequency offset estimation value by a smoothing coefficient and the modification coefficient to generate a smoothed frequency offset estimation value and further add a previous frequency offset estimation value and the smoothed frequency offset estimation value to generate a current frequency offset estimation value to update the frequency offset.

The present invention also discloses a communication method having a frequency tracking mechanism that includes steps outlined below. A current symbol section of a data part of a packet is received and a phase compensation is performed on the current symbol section according to a frequency offset to generate a phase-compensated symbol section by a phase compensation circuit. The phase-compensated symbol section is descrambled and equalized according to descrambling information by a symbol processing circuit to generate an equalization result, so as to perform calculation based on the equalization result to generate a phase difference and a data time difference between the phase-compensated symbol section and a previous symbol section. Calculation of a ratio between the phase difference and the data time difference is performed to generate an instant frequency offset estimation value by a residual frequency offset estimation circuit. Calculation on the data time difference is performed according to a function having a positive correlation with the data time difference to generate a modification coefficient by a frequency offset smoothing calculation circuit, so as to multiply the instant frequency offset estimation value by a smoothing coefficient and the modification coefficient to generate a smoothed frequency offset estimation value and further add a previous frequency offset estimation value and the smoothed frequency offset estimation value to generate a current frequency offset estimation value to update the frequency offset.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a circuit diagram of a communication apparatus having a frequency tracking mechanism according to an embodiment of the present invention.

FIG. 2A illustrates a diagram of the packet received by the communication apparatus according to an embodiment of the present invention.

FIG. 2B illustrates a diagram of a symbol section according to an embodiment of the present invention.

FIG. 3 illustrates a block diagram of the symbol processing circuit according to an embodiment of the present invention.

FIG. 4 illustrates a flow chart of a communication method having a frequency tracking mechanism according to an embodiment of the present invention.

### DETAILED DESCRIPTION OF THE PREFERRED EMBODIMENTS

One target of the present invention is to provide a communication apparatus and a communication method having a frequency tracking mechanism that configure a modification coefficient according to a data time difference to increase the weighting value of an instant frequency offset estimation value when a larger data time difference occurs under the condition that the difference of the positions of the actual data position between different symbol sections is larger, so as to update the frequency offset to increase the accuracy of the frequency offset estimation.

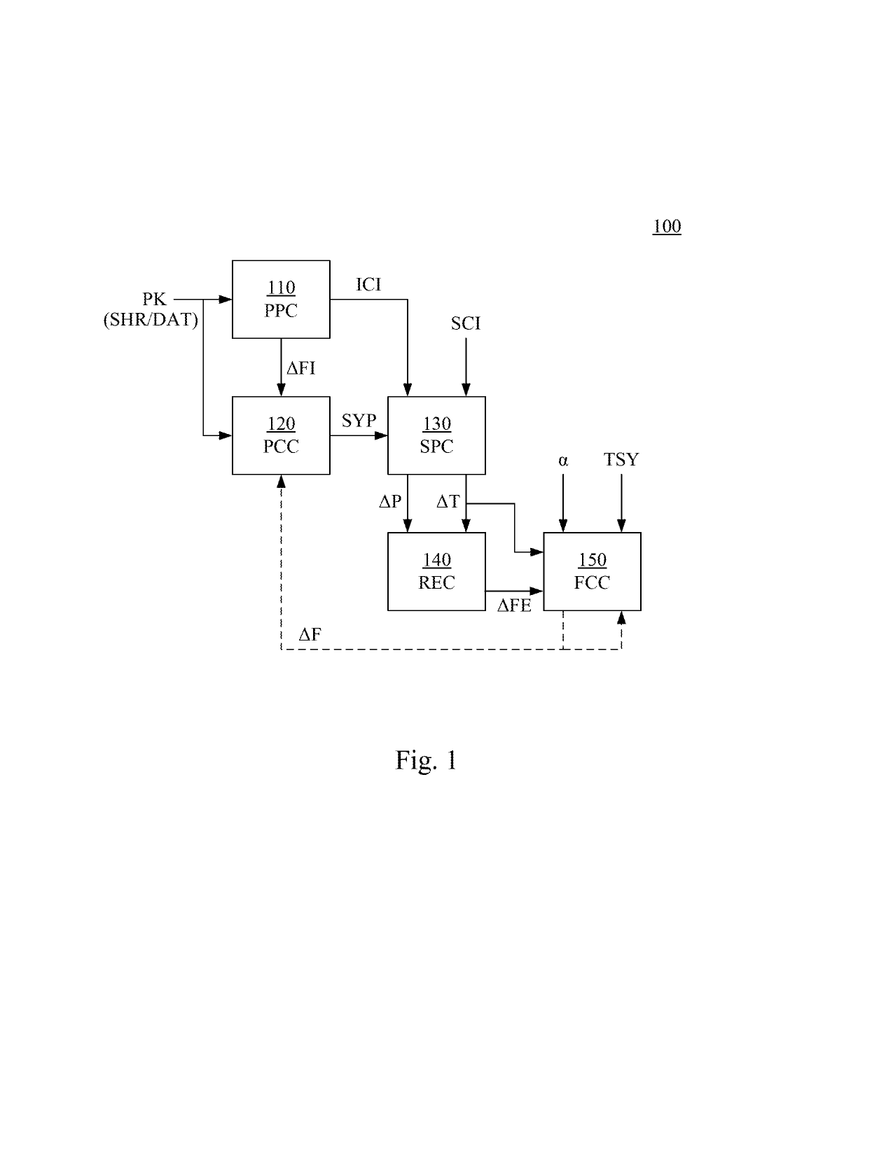

Reference is now made to FIG. 1. FIG. 1 illustrates a circuit diagram of a communication apparatus 100 having a frequency tracking mechanism according to an embodiment of the present invention. The communication apparatus 100 can be any apparatus that can perform wireless communication to further perform signal receiving.

In an embodiment, the communication apparatus 100 is a system that utilizes Burst Position Modulation (BPM) technology, e.g., the Ultra Wide Band (UWB) system of 802.15.4 protocol, to receive a packet PK when the signal receiving is performed.

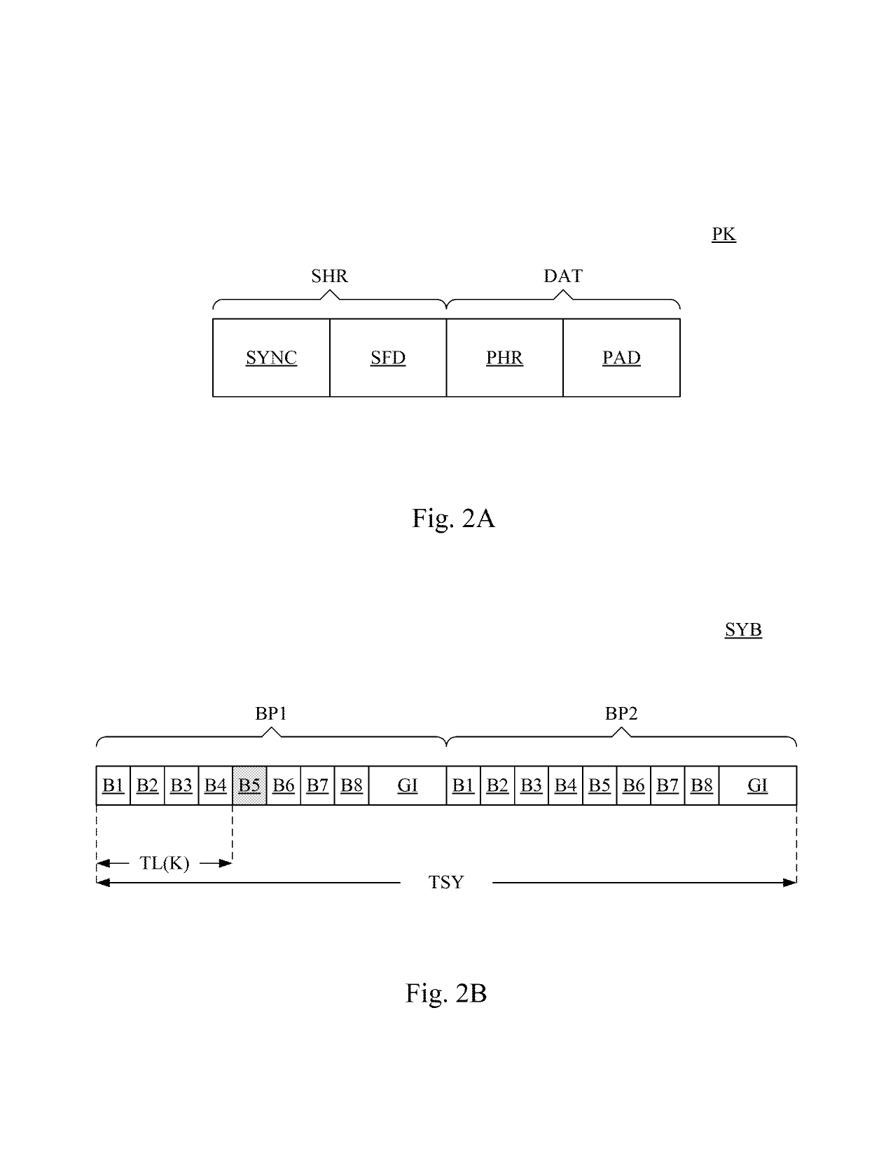

Reference is now made to FIG. 2A. FIG. 2A illustrates a diagram of the packet PK received by the communication apparatus 100 according to an embodiment of the present invention.

Take the UWB system as an example, the packet PK in turn includes a synchronization header part SHR and a data part DAT. The synchronization header part SHR includes a synchronization section SYNC and a start of frame delimiter section SFD. The data part DAT includes a physical layer header section PHR and a payload section PAD. The physical layer header section PHR and the payload section PAD utilizes burst positions modulation and includes one or more than one symbol sections.

Reference is now made to FIG. 2B. FIG. 2B illustrates a diagram of a symbol section SYB according to an embodiment of the present invention.

The symbol section SYB has a symbol time length TSY. In a numerical example, the symbol time length TSY is 8 microsecond (μs). The symbol section SYB includes a first half section BP1 and a second half section BP2, each including a plurality possible burst positions B1~B8. In an embodiment, each of the first half section BP1 and the second half section BP2 includes a guard interval GI behind the burst positions B1~B8. It is appreciated that the ratio between the total length of the burst positions B1~B8 and the length of the guard interval GI in FIG. 2B is illustrated for reference only. Actually, the ratio between the total length of the burst positions B1~B8 and the length of the guard interval GI can be 1:1 or other ratios depending on practical requirements.

According to the burst position modulation, the symbol section SYB only includes the actual data in one of the burst positions described above according to the scrambling performed on the packet PK by a transmission terminal that transmits the packet PK. As a result, for the actual data in the symbol section SYB, the actual data position includes an actual section and an actual burst position. For example, when the actual data is at the burst position illustrated as a grey area in FIG. 2B, the actual section of the actual data position is the first half section BP1, and the actual burst position is the fifth burst position B5.

Due to the performance of the burst position modulation, the actual data positions of different symbol sections SYB are different to lower the communication interference between different equipments. Under the condition that the ratio between the total length of the burst positions B1~B8 and the length of the guard interval GI is 1:1, the largest difference between the actual data positions of two neighboring symbol sections SYB is 7/4 of the symbol time length TSY, in which the actual data position of the former symbol section SYB corresponds to the first burst position B1 of the first half section BP1 and the actual data position of the latter symbol section SYB corresponds to the eighth burst position B8 of the second half section BP2. The smallest difference between the actual data positions of two neighboring symbol sections SYB is 1/4, in which the actual data position of the former symbol section SYB corresponds to the eighth burst position B8 of the second half section BP2 and the actual data position of the latter symbol section SYB corresponds to the first burst position B1 of the first half section BP1.

The communication apparatus 100 in FIG. 1 includes a pre-processing circuit 110 (abbreviated as PPC in FIG. 1), a phase compensation circuit 120 (abbreviated as PCC in FIG. 1), a symbol processing circuit 130 (abbreviated as SPC in FIG. 1), a residual frequency offset estimation circuit 140 (abbreviated as REC in FIG. 1) and a frequency offset smoothing calculation circuit 150 (abbreviated as FCC in FIG. 1). Based on the configuration and operation of the circuits described above, the communication apparatus 100 can process the packet PK and accomplish the object of frequency offset tracking to increase the accuracy of the data receiving.

Take the configuration of the packet PK illustrated in FIG. 2A and FIG. 2B as an example, the configuration and the operation of the communication apparatus 100 are described in the following paragraphs.

The pre-processing circuit 110 is configured to process the synchronization header part SHR in front of the data part DAT to generate an initial value ΔFI of the frequency offset ΔF and initial channel information ICI.

The phase compensation circuit 120 is configured to receive a current symbol section (e.g., the symbol section SYB in FIG. 2B) of the data part DAT of the packet PK and perform a phase compensation on the current symbol section according to a frequency offset ΔF to generate a phase-compensated symbol section SYP, wherein current symbol section has a symbol time length (e.g., the symbol time length TSY in FIG. 2B).

The symbol processing circuit 130 is configured to descramble and equalize the phase-compensated symbol section SYP according to descrambling information SCI to generate an equalization result, so as to perform calculation based on the equalization result to generate a phase difference ΔP and a data time difference ΔT between the phase-compensated symbol section SYP and a previous symbol section. In an embodiment, the descrambling information SCI is calculated from a symbol index of a preamble sequence of the packet PK. The detail calculation method can be referred to the content of the protocol and is not described herein.

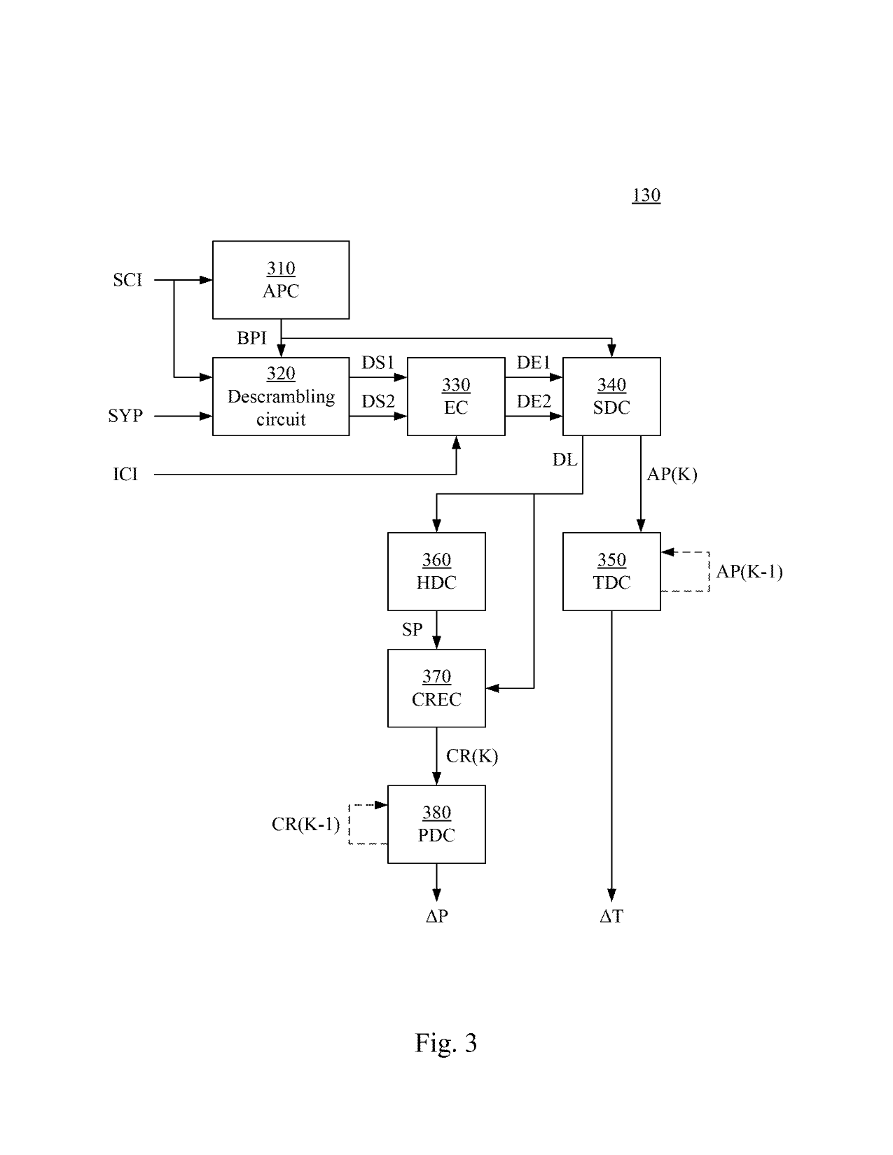

Reference is now made to FIG. 3. FIG. 3 illustrates a block diagram of the symbol processing circuit 130 according to an embodiment of the present invention. The symbol processing circuit 130 includes an actual data position calculation circuit 310 (abbreviated as APC in FIG. 3), a descrambling circuit 320, an equalization circuit 330 (abbreviated as EC in FIG. 3), a section determining circuit 340 (abbreviated as SDC in FIG. 3), a time difference calculation circuit 350 (abbreviated as TDC in FIG. 3), a hard decision circuit 360 (abbreviated as HDC in FIG. 3), a channel re-estimation circuit 370 (abbreviated as CREC in FIG. 3) and a phase difference calculation circuit 380 (abbreviated as PDC in FIG. 3).

The actual data position calculation circuit 310 is configured to perform calculation on the current symbol section AP(K) according to the descrambling information, so as to determine an actual burst position included by the actual data position from the plurality of burst positions (e.g., the burst positions B1~B8 in the first half section BP1 and the second half section BP2 in FIG. 2B) to generate burst position information BPI. In the current actual data position AP(K), K stands for the current time spot.

More specifically, according to the descrambling information SCI, the actual data position calculation circuit 310 can only determine the actual burst position of the current actual data position AP(K), but cannot determine the actual section of the current actual data position AP(K).

The descrambling circuit 320 is configured to descramble the phase-compensated symbol section SYP according to the descrambling information SCI and the burst position information BPI to generate first descrambled data DS1 corresponding to the first half section BP1 and second descrambled data DS2 corresponding to the second half section BP2.

The equalization circuit 330 is configured to equalize the first descrambled data DS1 and the second descrambled data DS2 according to initial channel information ICI to generate first equalized data DE1 and second equalized data DE2 as the equalization result.

The section determining circuit 340 is configured to select one of the first equalized data DE1 and the second equalized data DE2 having a larger energy to be selected equalized data DL, so as to determine the actual section included by the current actual data position AP(K) from the first half section BP1 and the second half section BP2 according to the selected equalized data DL.

In an embodiment, each of the first equalized data DE1 and the second equalized data DE2 is a complex number. The section determining circuit 340 is configured to perform energy calculation respectively on the first equalized data DE1 and the second equalized data DE2 to determine one of the first equalized data DE1 and the second equalized data DE2 that has the larger energy. For example, when the first equalized data DE1 is expressed by the complex number of a+bi, the section determining circuit 340 adds a square of the real part a and the square of the imaginary part b to determine the energy thereof.

More specifically, the descrambling circuit 320 performs descrambling based on the condition that the actual section is located in the first half section BP1 and based on the condition that the actual section is located in the second half section BP2 according to the burst position information BPI to generate descrambling results. After the equalization circuit 330 performs equalization on the descrambling results, the section determining circuit 340 determines one of the first equalized data DE1 and the second equalized data DE2 having the larger energy to further determine that the one of the first equalized data DE1 and the second equalized data DE2 having the larger energy corresponds to the actual section that actually has data.

In an embodiment, the section determining circuit 340 may receive the burst position information BPI from the actual data position calculation circuit 310 to obtain the actual burst position included by the current actual data position AP(K) and further obtain the actual section included by the current actual data position AP(K) according to the generation of the selected equalized data DL.

In an embodiment, the section determining circuit 340 may indicate the current actual data position AP(K) by using a current time length relative to the current symbol section initial position of the current symbol section. Take the burst position illustrated as a grey area in FIG. 2B (i.e., the fifth burst position B5 in the first half section BP1) that the current actual data position AP(K) corresponds to as an example, the current actual data position AP(K) is indicated as the current time length TL(K) from the first burst position B1 of the first half section BP1 to the fifth burst position B5 of the first half section BP1. The section determining circuit 340 further transmits the current actual data position AP(K) to the time difference calculation circuit 350 to perform calculation accordingly.

The time difference calculation circuit 350 is configured to calculate the data time difference ΔT according to the current actual data position AP(K) and a previous actual data position AP(K-1) corresponding to the previous symbol section. In the previous actual data position AP(K-1), K-1 stands for a previous time spot.

Similar to the current actual data position AP(K), the previous actual data position AP(K-1) can be indicated by using a previous time length TL(K-1) relative to the previous symbol section initial position of the previous symbol section. The time difference calculation circuit 350 is configured to subtract the previous time length TL(K-1) from the current time length TL(K) and add the symbol time length TSY to the subtracted result to calculate the data time difference ΔT, which is expressed as ΔT=TL(K)-TL(K-1)+TSY.

The hard decision circuit 360 is configured to perform a hard decision on the selected equalized data DL to generate a real part sign parameter SP. The hard decision is used to estimate the original transmitted data according to the equalized data to eliminate the influence of the original transmitted data difference when the phase difference between symbols is calculated. In UWB protocol of the 802.15.4 system, the burst position modulated signal pulses are transmitted in the form of binary phase-shift keying (BPSK) such that the result of the hard decision is either 1 or -1. More specifically, when the selected equalized data DL is expressed in the form of the complex number a+bi described above, the hard decision circuit 360 take the sign of a as the real part sign parameter SP. In a numerical example, the real part sign parameter SP is 1 when the sign of a is positive and is -1 when the sign of a is negative.

The channel re-estimation circuit 370 is configured to divide the selected equalized data DL by the real part sign parameter SP to generate a current channel re-estimation result CR(K). More specifically, the current channel re-estimation result CR(K) can be expressed as CR(K)=DL/SP.

The phase difference calculation circuit 380 is configured to calculate the phase difference ΔP according to the current channel re-estimation result CR(K) and a previous channel re-estimation result CR(K-1).

In an embodiment, the phase difference calculation circuit 380 performs a calculation of a conjugate of the previous channel re-estimation result CR(K-1) and multiplies the calculation result of the conjugate by the current channel re-estimation result CR(K) to generate a multiplication result, so as to retrieve an angle from the multiplication result as the phase difference ΔP. As a result, the phase difference ΔP can be expressed as ΔP=angle(CR(K)×conj(CR(K-1))).

Reference is now made to FIG. 1 again. The residual frequency offset estimation circuit 140 in FIG. 1 is configured to perform calculation of a ratio between the phase difference ΔP and the data time difference ΔT generated by the symbol processing circuit 130 to generate an instant frequency offset estimation value ΔFE. As a result, the instant frequency offset estimation value ΔFE is expressed as ΔFE=ΔP/ΔT.

The frequency offset smoothing calculation circuit 150 is configured to perform calculation on the data time difference ΔT according to a function having a positive correlation with the data time difference ΔT to generate a modification coefficient MP, so as to multiply the instant frequency offset estimation ΔFE by a smoothing coefficient α and the modification coefficient MP to generate a smoothed frequency offset estimation value ΔFS. In an embodiment, such a function can be a ratio of the data time difference ΔT and the symbol time length TSY.

The frequency offset ΔF corresponding to the time spot K is used to perform the phase compensation by the phase compensation circuit 120. As a result, the previous frequency offset estimation value is expressed as ΔF(K) such that the frequency offset smoothing calculation circuit 150 adds the previous frequency offset estimation value ΔF(K) and the smoothed frequency offset estimation value ΔFS to generate a current frequency offset estimation value ΔF(K+1) to update the frequency offset ΔF. Therefore, the frequency offset ΔF is expressed as ΔF=ΔF(K+1)=ΔF(K)+ΔFS=ΔF(K)+ΔFE×α×MP. In an embodiment, MP=(ΔT/TSY), such that ΔF =ΔF(K)+ΔFE×α× (ΔT/TSY).

In the parameters described above, the smoothing coefficient α is an optimal coefficient obtained according to the fixed symbol time length TSY and a specific signal-to-noise ratio and is fixed once it is selected. Further, some of the parameters are the terms generated during the calculation process and are not illustrated in FIG. 1.

After the frequency offset ΔF is finished being updated, the phase compensation circuit 120 performs the phase compensation on the current symbol section corresponding to the next time spot K+1 according to the frequency offset ΔF. The time difference calculation circuit 350 may treat the current actual data position AP(K) as the previous actual data position and perform calculation thereon with the current actual data position that the symbol section SYB of the next time spot correspond to, which can be expressed as AP(K+1). The phase difference calculation circuit 380 can treat the current channel re-estimation result CR(K) as the previous actual data position to perform calculation thereon with the current channel re-estimation result that the symbol section SYB of the next time spot correspond to, which can be expressed as CR(K+1). As a result, the communication apparatus 100 can keep performing frequency offset tracking according to the continuous feeding of the symbol section SYB of different time spots.

In some approaches, the update of the frequency offset ΔF(K) is performed according to the smoothing coefficient α that is fixed once it is selected. However, the actual data position in different symbol sections keeps varying in the burst position modulation such that the accuracy of the frequency offset estimation in different symbols varies. The method that uses the fixed smoothing coefficient cannot accomplish the best frequency offset estimation result.

The communication apparatus 100 of the present invention configures the modification coefficient MP according to the function having a positive correlation with the data time difference ΔT. When the difference of the actual data positions between different symbol sections is larger such that the data time difference ΔT is larger, the weighting value of the instant frequency offset estimation value ΔFE is increased to update the frequency offset ΔF(K). The accuracy of the frequency offset estimation is thus improved. The processing is based on the fact that the accuracy of the frequency offset estimation is higher when the time interval is larger.

In a numerical example, when 1% packet error rate (PER) is required to be accomplished under the condition that the average pulse repetition frequency (PRF) is 15.6 MHz and data rate is 110 kbps, the required signal-to-noise ratio under the condition that the dynamic adjustment of the smoothing coefficient is used based on the configuration of the modification coefficient (e.g., according to the ratio between the data time difference and the symbol time length) is lower for 1dB than the required signal-to-noise ratio under the condition that the fixed smoothing coefficient is used.

It is appreciated that in FIG. 1, only the circuits to perform signal receiving are illustrated. In other embodiments, the communication apparatus 100 may also include the circuits to perform signal transmission. The present invention is not limited thereto.

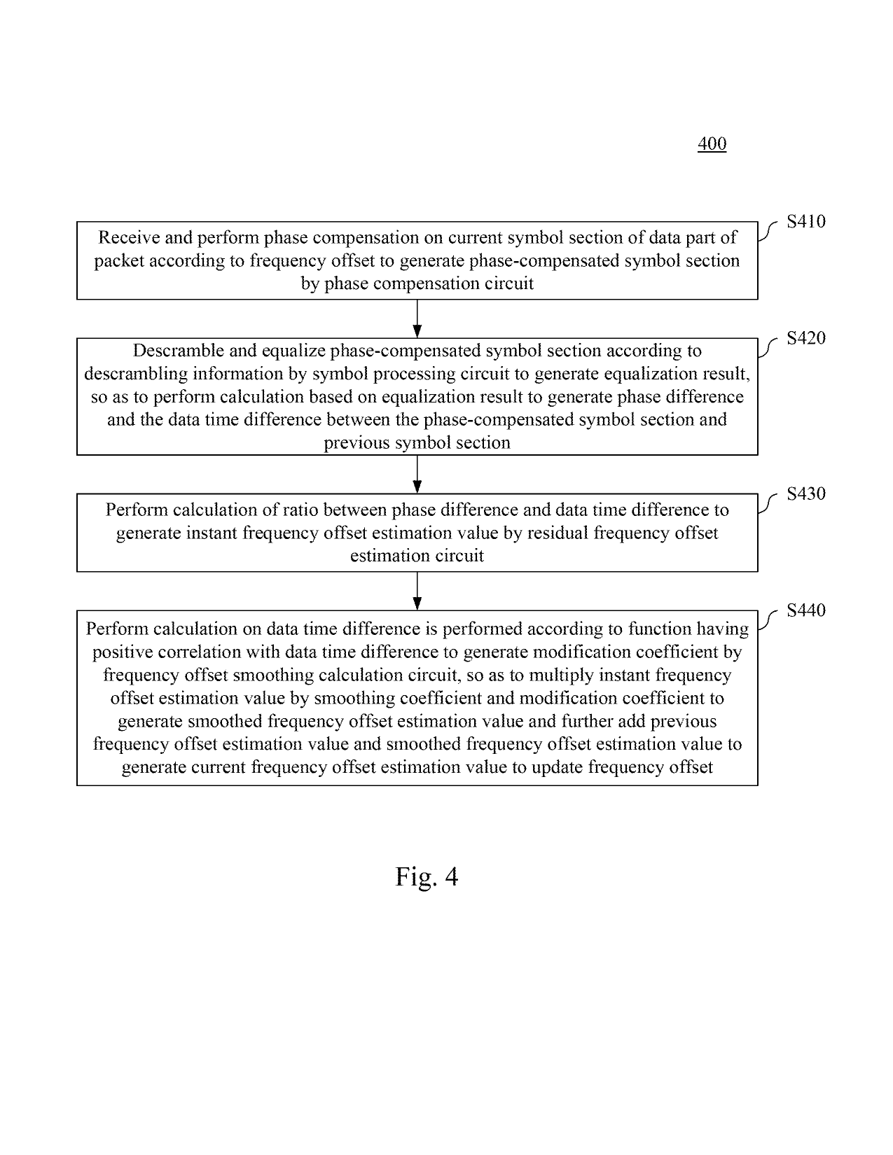

Reference is now made to FIG. 4. FIG. 4 illustrates a flow chart of a communication method 400 having a frequency tracking mechanism according to an embodiment of the present invention.

In addition to the apparatus described above, the present invention further provides the communication method 400 having the frequency tracking mechanism that can be used in such as, but not limited to, the communication apparatus 100 in FIG. 1. As illustrated in FIG. 4, an embodiment of the communication method 400 includes the following steps.

In step S410, the current symbol section (e.g., the symbol section SYB in FIG. 2B) of the data part DAT of the packet PK is received and a phase compensation is performed on the current symbol section according to the frequency offset ΔF(K) to generate the phase-compensated symbol section SYP by the phase compensation circuit 120.

In step S420, the phase-compensated symbol section SYP is descrambled and equalized according to the descrambling information SCI by the symbol processing circuit 130 to generate the equalization result, so as to perform calculation based on the equalization result to generate the phase difference ΔP and the data time difference ΔT between the phase-compensated symbol section SYP and the previous symbol section.

In step S430, calculation of the ratio between the phase difference ΔP and the data time difference ΔT is performed to generate the instant frequency offset estimation value ΔF by the residual frequency offset estimation circuit 140.

In step S440, calculation on the data time difference ΔT is performed according to the function having the positive correlation with the data time difference ΔT to generate the modification coefficient MP by the frequency offset smoothing calculation circuit 150, so as to multiply the instant frequency offset estimation value ΔFE by the smoothing coefficient α and the modification coefficient MP to generate the smoothed frequency offset estimation value and further add a previous frequency offset estimation value and the smoothed frequency offset estimation value ΔFS to generate the current frequency offset estimation value to update the frequency offset ΔF(K).

It is appreciated that the embodiments described above are merely an example. In other embodiments, it should be appreciated that many modifications and changes may be made by those of ordinary skill in the art without departing from the spirit of the disclosure. For example, the method used to generate the phase difference and data time difference described above is merely an example. In other embodiments, other circuit configurations and operation mechanisms can be used to implement the symbol processing circuit to generate the phase difference and the data time difference. Moreover, the apparatus that is implemented based on the UWB system of 802.15.4 protocol is merely an example. In other embodiments, other technologies that transmit data with non-equal interval can be used to implement the communication apparatus. The present invention is not limited thereto.

In summary, the present invention discloses the communication apparatus and the communication method having the frequency tracking mechanism configure a modification coefficient according to a data time difference to increase the weighting value of an instant frequency offset estimation value when a larger data time difference occurs under the condition that the difference of the positions of the actual data position between different symbol sections is larger, so as to update the frequency offset to increase the accuracy of the frequency offset estimation..

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A communication apparatus having a frequency tracking mechanism, comprising:
a phase compensation circuit configured to receive a current symbol section of a data part of a packet and perform a phase compensation on the current symbol section according to a frequency offset to generate a phase-compensated symbol section;
a symbol processing circuit configured to descramble and equalize the phase-compensated symbol section according to descrambling information to generate an equalization result, so as to perform calculation based on the equalization result to generate a phase difference and a data time difference between the phase-compensated symbol section and a previous symbol section;
a residual frequency offset estimation circuit configured to perform calculation of a ratio between the phase difference and the data time difference to generate an instant frequency offset estimation value; and
a frequency offset smoothing calculation circuit configured to perform calculation on the data time difference according to a function having a positive correlation with the data time difference to generate a modification coefficient, so as to multiply the instant frequency offset estimation value by a smoothing coefficient and the modification coefficient to generate a smoothed frequency offset estimation value and further add a previous frequency offset estimation value and the smoothed frequency offset estimation value to generate a current frequency offset estimation value to update the frequency offset.

2. The communication apparatus of claim 1, wherein the current symbol section comprises a first half section and a second half section and each of the first half section and the second half section comprises a plurality of possible burst positions, the symbol processing circuit comprising:
an actual data position calculation circuit configured to perform calculation on the current symbol section according to the descrambling information, so as to determine an actual burst position comprised by an actual data position from the plurality of burst positions to generate burst position information;
a descrambling circuit configured to descramble the phase-compensated symbol section according to the descrambling information and the burst position information to generate first descrambled data corresponding to the first half section and second descrambled data corresponding to the second half section;
an equalization circuit configured to equalize the first descrambled data and the second descrambled data according to initial channel information to generate first equalized data and second equalized data as the equalization result;
a section determining circuit configured to select one of the first equalized data and the second equalized data having a larger energy to be selected equalized data, so as to determine an actual section comprised by the current actual data position from the first half section and the second half section according to the selected equalized data; and
a time difference calculation circuit configured to calculate the data time difference according to the current actual data position and a previous actual data position corresponding to the previous symbol section.

3. The communication apparatus of claim 2, further comprising a pre-processing circuit configured to process a synchronization header part in front of the data part to generate an initial value of the frequency offset and the initial channel information.

4. The communication apparatus of claim 2, wherein each of the first equalized data and the second equalized data is a complex number and the section determining circuit is configured to perform an energy calculation respectively on the first equalized data and the second equalized data to determine one of the first equalized data and the second equalized data having the larger energy.

5. The communication apparatus of claim 2, wherein the current symbol section has a symbol time length, the current actual data position corresponds to a current time length relative to a current symbol section initial position of the current symbol section, the previous actual data position corresponds to a previous time length relative to a previous symbol section initial position of a previous symbol section, and the time difference calculation circuit is configured to subtract the previous time length from the current time length and add the subtraction result and the symbol time length to calculate the data time difference.

6. The communication apparatus of claim 2, wherein the symbol processing circuit further comprises:
a hard decision circuit configured to perform a hard decision on the selected equalized data to generate a real part sign parameter;
a channel re-estimation circuit configured to divide the selected equalized data by the real part sign parameter to generate a current channel re-estimation result; and
a phase difference calculation circuit configured to calculate the phase difference according to the current channel re-estimation result and a previous channel re-estimation result.

7. The communication apparatus of claim 6, wherein the phase difference calculation circuit performs a calculation of a conjugate of the previous channel re-estimation result and multiplies a calculation result of the conjugate by the current channel re-estimation result to generate a multiplication result, so as to retrieve an angle from the multiplication result as the phase difference.

8. The communication apparatus of claim 1, wherein the current symbol section has a symbol time length, and the function is a ratio between the data time difference and the symbol time length.

9. A communication method having a frequency tracking mechanism, comprising:
receiving a current symbol section of a data part of a packet and performing a phase compensation on the current symbol section according to a frequency offset to generate a phase-compensated symbol section;
descrambling and equalizing the phase-compensated symbol section according to descrambling information by a symbol processing circuit to generate an equalization result, so as to perform calculation based on the equalization result to generate a phase difference and a data time difference between the phase-compensated symbol section and a previous symbol section;
performing calculation of a ratio between the phase difference and the data time difference to generate an instant frequency offset estimation value by a residual frequency offset estimation circuit; and
performing calculation on the data time difference according to a function having a positive correlation with the data time difference to generate a modification coefficient by a frequency offset smoothing calculation circuit, so as to multiply the instant frequency offset estimation value by a smoothing coefficient and the modification coefficient to generate a smoothed frequency offset estimation value and further add a previous frequency offset estimation value and the smoothed frequency offset estimation value to generate a current frequency offset estimation value to update the frequency offset.

10. The communication method of claim 9, the current symbol section comprises a first half section and a second half section and each of the first half section and the second half section comprises a plurality of possible burst positions, the communication method comprising:
performing calculation on the current symbol section according to the descrambling information by an actual data position calculation circuit comprised by the symbol processing circuit, so as to determine an actual burst position comprised by an actual data position from the plurality of burst positions to generate burst position information;
descrambling the phase-compensated symbol section according to the descrambling information and the burst position information to generate first descrambled data corresponding to the first half section and second descrambled data corresponding to the second half section by a descrambling circuit comprised by the symbol processing circuit;
equalizing the first descrambled data and the second descrambled data according to initial channel information to generate first equalized data and second equalized data as the equalization result by an equalization circuit comprised by the symbol processing circuit;
selecting one of the first equalized data and the second equalized data having a larger energy to be selected equalized data by a section determining circuit comprised by the symbol processing circuit, so as to determine an actual section comprised by the current actual data position from the first half section and the second half section according to the selected equalized data; and
calculating the data time difference according to the current actual data position and a previous actual data position corresponding to the previous symbol section by a time difference calculation circuit comprised by the symbol processing circuit.

11. The communication method of claim 10, further comprising:
processing a synchronization header part in front of the data part to generate an initial value of the frequency offset and the initial channel information by a pre-processing circuit.

12. The communication method of claim 10, wherein each of the first equalized data and the second equalized data is a complex number, the communication method further comprising:
performing an energy calculation respectively on the first equalized data and the second equalized data to determine one of the first equalized data and the second equalized data having the larger energy by the section determining circuit.

13. The communication method of claim 10, wherein the current symbol section has a symbol time length, the current actual data position corresponds to a current time length relative to a current symbol section initial position of the current symbol section, the previous actual data position corresponds to a previous time length relative to a previous symbol section initial position of a previous symbol section, the communication method further comprising:
subtracting the current time length from the previous time length and adding the subtraction result and the symbol time length to calculate the data time difference by the time difference calculation circuit.

14. The communication method of claim 10, further comprising:
performing a hard decision on the selected equalized data to generate a real part sign parameter by a hard decision circuit comprised by the symbol processing circuit;
dividing the selected equalized data by the real part sign parameter to generate a current channel re-estimation result by a channel re-estimation circuit comprised by the symbol processing circuit;
calculating the phase difference according to the current channel re-estimation result and a previous channel re-estimation result by a phase difference calculation circuit comprised by the symbol processing circuit.

15. The communication method of claim 14, further comprising:
performing a calculation of a conjugate of the previous channel re-estimation result and multiplying a calculation result of the conjugate by the current channel re-estimation result to generate a multiplication result by the phase difference calculation circuit, so as to retrieve an angle from the multiplication result as the phase difference.

16. The communication method of claim 9, wherein the current symbol section has a symbol time length, and the function is a ratio between the data time difference and the symbol time length.
